(19) United States
(12) Patent Application Publication
(10) Pub. No.: US 2006/0033000 A1
(43) Pub. Date: Feb. 16, 2006

(54) Hanger bar for ceiling light fixture

(76) Inventor: Ae-Sook Seo, Nonsan-si (KR)

Correspondence Address: PARK LAW FIRM, 3255 WILSHIRE BLVD, SUITE 1110, LOS ANGELES, CA, 90010, US

(21) Appl. No.: 11/106,104

(22) Filed: Apr. 15, 2005

(30) Foreign Application Priority Data
Aug. 12, 2004 (KR) 20-2004-0023097

(51) Int. Cl. B42F 13/00

(52) U.S. Cl. 248/343

(57) ABSTRACT

A hanger bar for mounting a ceiling light fixture is formed of shortening the length thereof, thereby mounting regardless of the width of the ceiling frame and comprises first and second bars having cutting lines formed at regular intervals. The first bar has folding hooks formed along the longitudinal direction on both sides of the crosswise direction thereof. The second bar has a convex part protruded to one side along the longitudinal direction. The second bar is mounted to slide in the folding hooks of the first bar. Coupling parts for attaching the bars are formed in each end of the bars as one body. The coupling parts are folded perpendicular to the surface of the bars and has coupling members formed by punching. The coupling member has a chock, so that the hanger bar can be coupled with the ceiling frame by using a simple stroke.

### CLAIMING FOREIGN PRIORITY

The applicant claims and requests a foreign priority, through the Paris Convention for the Protection of Industry Property, based on patent application filed in the Republic of Korea (South Korea) with application number 20-2004-0023096, filed Aug. 12, 2004 by the applicant. (See the attached Declaration)

### BACKGROUND OF THE INVENTION

1. Field of the Invention

The present invention relates to an apparatus for mounting a ceiling light fixture, more particularly to a hanger bar for holding the ceiling light fixture in a ceiling.

2. Description of the Related Arts

In a ceiling of buildings, generally, a ceiling frame for mounting a light fixture is arranged away from the ceiling at an interval and ceiling boards are attached on the frame. The ceiling frame is made of wood or metal and the light fixture is equipped to insert into the ceiling boards or protrude outward.

In the case of inserting a light fixture into a ceiling board, an aperture is formed on the ceiling board to which an apparatus for mounting the light fixture is directly coupled. Then, the apparatus and the light fixture are held up by the supporting force of the ceiling board, but the board is made of a thin square plate so that the supporting force is weak. Therefore, the conventional method for mounting a ceiling light fixture has problems that the light fixture may be fallen away from the ceiling board and then broken.

To attach stably the light fixture on the ceiling, a board-type frame and a hanger bar are arranged to mount the light fixture. The hanger bar is inserted into hooking apertures formed on both sides of the board-type frame and coupled to the ceiling frame. The hanger bar is mounted on the ceiling frame by nailing or screwing, and the length of the hanger bar can be expanded to adapt easily to several intervals of the ceiling frame.

In above described conventional method, however, it is difficult to mount the hanger bar on the ceiling frame having an interval less than a predetermined interval. Further, since nailing or clipping is used for coupling, it takes much time to couple the hanger bar on a desired position.

### SUMMARY OF THE INVENTION

The present invention has been developed to solve the problems with above-described hanger bar.

It is an object of the present invention to provide a hanger bar for a ceiling light fixture which is capable of shortening as well as extending and whose parts are not entirely separated from each other.

It is another object of the present invention to provide a hanger bar, which is easily coupled on a ceiling frame by only a simple stroking.

In accomplishing the above and other objectives, a hanger bar for mounting a ceiling light fixture according to the present invention comprises first bar and second bars having a plurality of cutting lines formed at regular intervals, respectively. The first bar has folding hooks formed along the longitudinal direction on both sides of the crosswise direction thereof. The second bar has a convex part protruded to one side thereof along the longitudinal direction. The second bar is mounted to slide in the folding hooks of the first bar. Coupling parts for attaching the first and second bars are formed in each end of the first and second bars as one body. The coupling parts are folded perpendicular to the surface of the first and second bars and has coupling members formed by punching.

The cutting lines are formed to adjust the length of the first and second bars. If the interval of a ceiling frame is less than the length of the first and second bars, the length of the first and second bars is shortened by cutting the bars along the cutting lines.

The coupling member is extended from the coupling part in a bar-shape, bent in hook-shape, and has a sharp chock in the end thereof, which is toward the direction opposite to the bars. A plurality of wedge-shaped boss may be formed on both sides of the chock, thereby improving the coupling force of the chock.

The coupling part further comprises coupling holes for nailing or screwing. The coupling holes are formed on the upper and lower sides of the coupling part. For tightly coupling the hanger bar to a ceiling frame, firstly, the hanger bar is fixed by the chock, and secondly, nailed or screwed through the coupling holes.

The first and second bars have first and second protrusions, which are formed in the ends of the bars opposite to each coupling part, respectively. The first protrusion is protruded toward the opened direction between the folding hooks, and the second protrusion is protruded toward the inside of the convex part 31. When the second bar is mounted to slide in the first bar, the first and second protrusions are hooked each other to prevent the second bar from taking away from the first bar.

The first and second protrusions are formed on the cutting lines close to each coupling part, respectively. Therefore, it is possible to prevent the second bar from taking away without cutting for adjusting the length of the hanger bar.

Alternatively, one bar has a plurality of hooking holes along the longitudinal direction thereof and the other bar has a plurality of bosses for corresponding to the hooking holes, so that the first bar is hooked to the second bar by coupling the hooking holes with the bosses. Thus, it is possible to prevent one bar from taking away from the other bar.

Further, an opening part is formed on a side of the coupling part of the first bar to pass through the second bar mounted to slide in the first bar.

Further, a subsidiary is formed on the coupling parts for attaching the first and second bars to be protruded in order to maintain in constant a coupling position for the sharp chock and the ceiling frame. Therefore, the subsidiary can be positioned on the upper part of the ceiling frame.

### BRIEF DESCRIPTION OF THE DRAWINGS

FIG. 1 is a perspective view showing a hanger bar for a ceiling light fixture according to an embodiment of the present invention.

FIG. 2 is a plan view showing a hanger bar for a ceiling light fixture according to the embodiment of the present invention.

FIG. 3 is a cross-sectional view taken along line A-A of FIG. 2.

FIG. 4 is a cross-sectional view taken along line B-B of FIG. 2.

FIG. 5 is a partial cross-sectional view showing a hanger bar according to the embodiment of the present invention.

FIG. 6 is a perspective view showing a hanger bar for a ceiling light fixture according to another embodiment of the present invention.

### DETAILED DESCRIPTION OF THE EMBODIMENTS

Referring now to attaching the drawings, the hanger bar for a ceiling light fixture according to an embodiment of the present invention will be described in detail. It is noted that like parts are designated by like reference numerals throughout the accompanying drawings.

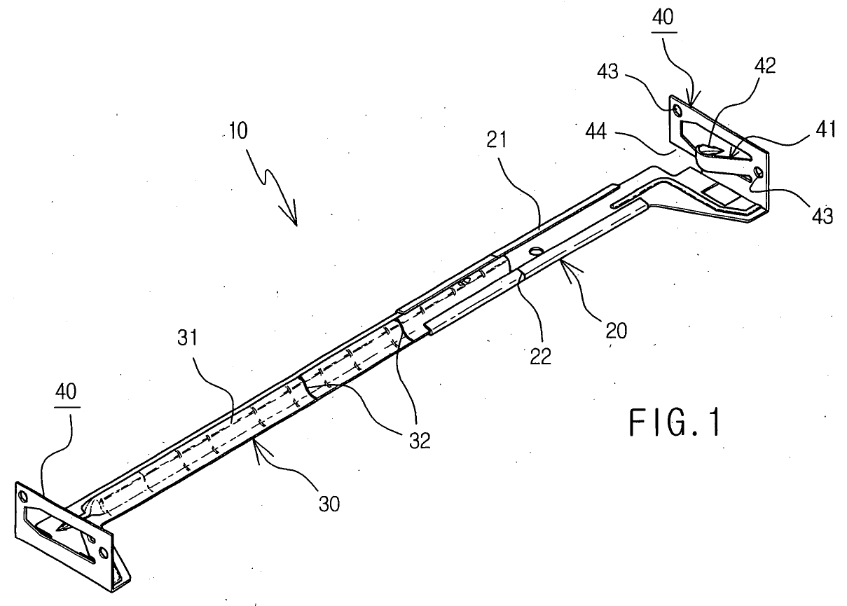

FIG. 1 to 5 shows a hanger bar for a ceiling light fixture according to an embodiment of the present invention.

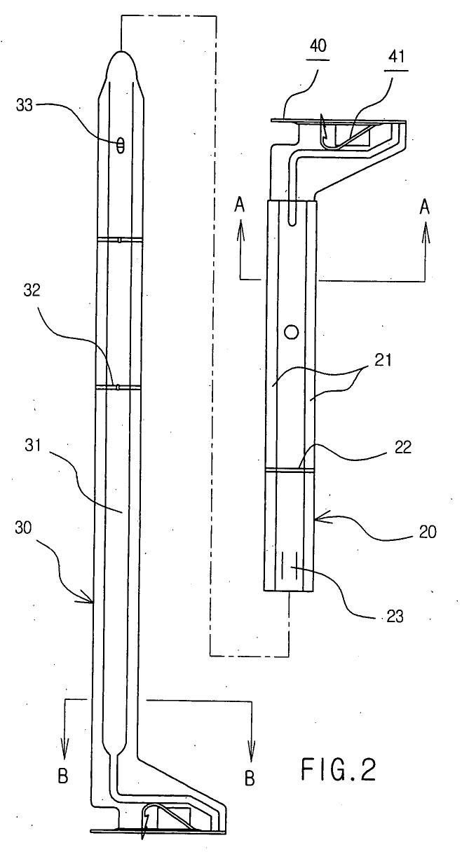

As shown FIG. 1 and FIG. 2, a hanger bar 10 for a ceiling light fixture comprises a first bar 20, a second bar 30 and coupling parts 40 formed on both ends of the first and second bars as one body.

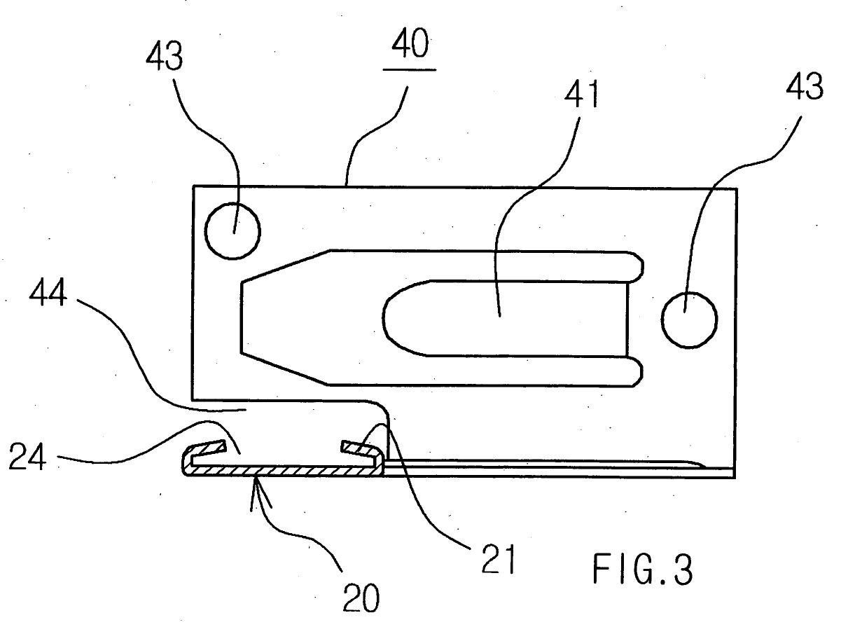

On both sides of the first bar 20 in the crosswise direction, two folding hooks 21 are formed in the longitudinal direction, respectively. As shown FIG. 3, each folding hook 21 is folded inward and an opening 24 is formed between the folding hooks.

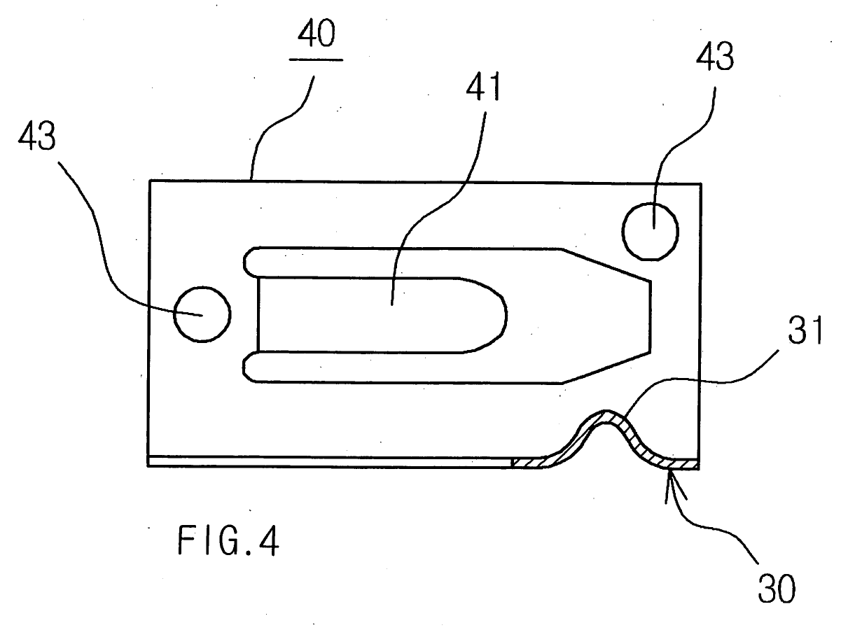

The second bar 30 is mounted to slide in the folding hooks 21 of the first bar 20, and has a convex part 31 on one side thereof. The convex part 31 is protruded in the longitudinal direction of the second bar 30, as shown FIG. 1 and 4.

The convex part 31 is protruded on the opening between the folding hooks 21 of the first bar 20. When a user takes the hanger bar in his hand, the hand touches not the folding hooks 21 but the convex part 32. Thus, it is possible to prevent the user's hand from hurting by a sharp cut end of the folding hooks 21.

A plurality of cutting lines 22, 32 is formed on the first and second bars 20, 30 at regular interval. The length of each bar can be adjusted by cutting the bars along the cutting lines 22, 32. Therefore, the hanger bar 10 can be also adapted to a ceiling frame whose width is less than the standard length of the hanger bar.

Coupling parts 40 for attaching the hanger bar 10 to the ceiling frame are formed in each end of the first and second bars 20, 30 as one body. The coupling parts 40 are folded perpendicular to the surface of the first and second bars 20, 30 and the width of it is wider than that of the first and second bars 20, 30.

Further, a coupling member 41 having a sharp chock 42 is formed on each coupling part 40. The coupling member 41 is extended from the coupling part 40 and formed by punching. The coupling member 41 is bent in a hook-shape so that the chock 42 is toward the direction opposite to the first and second bars 20, 30.

With the hook-shaped coupling member 41, the coupling parts are attached to the surface of the ceiling frame. Then, the chock 42 is perpendicular to the surface so that the coupling member 41 is coupled to the ceiling frame with a simple stroke.

Each coupling part 40 has coupling holes 43 on the upper and lower sides of the coupling member 41. The hanger bar 10 is coupled to the ceiling frame by nailing or screwing through coupling holes 43. Therefore, the hanger bar 10 and the ceiling frame have three coupling points, that is, the two coupling holes 43 formed on both ends of the coupling part 40 and the chock 42 of the coupling member 42. Thus, the hanger bar 10 can be safely coupled to the ceiling frame without twist.

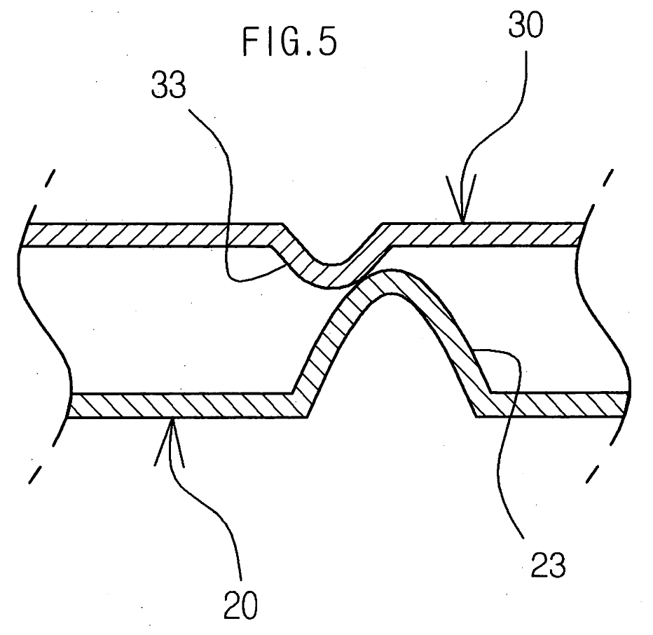

On the other hand, as shown FIG. 5, the hanger bar 10 has a first protrusion 23 formed on the first bar 20 and a second protrusion 33 formed on the second bar 30. The first and second protrusions 23, 33 are formed in the ends of the bars opposite to each coupling part 40, respectively. The first protrusion 23 of the first bar 20 is protruded toward the opened direction between the folding hooks 21, and the second protrusion 33 of the second bar 30 is protruded toward the inside of the convex part 31.

When the second bar 30 is mounted to slide in the first bar 20, firstly, the first and second protrusions 23, 33 are contacted and hooked each other. Secondly, if more force is applied to the bars 20, 30, the protrusions 23, 33 are temporarily elastic-transformed so that the second bar 30 is deeply coupled to the inside of the first bar 20. On the contrary, when the second bar 30 is pulled from the first bar 20 to lengthen the hanger bar 10 to the maximum length, firstly, the first and second protrusions 23, 33 are hooked to prevent the second bar 30 from taking away from the first bar 20.

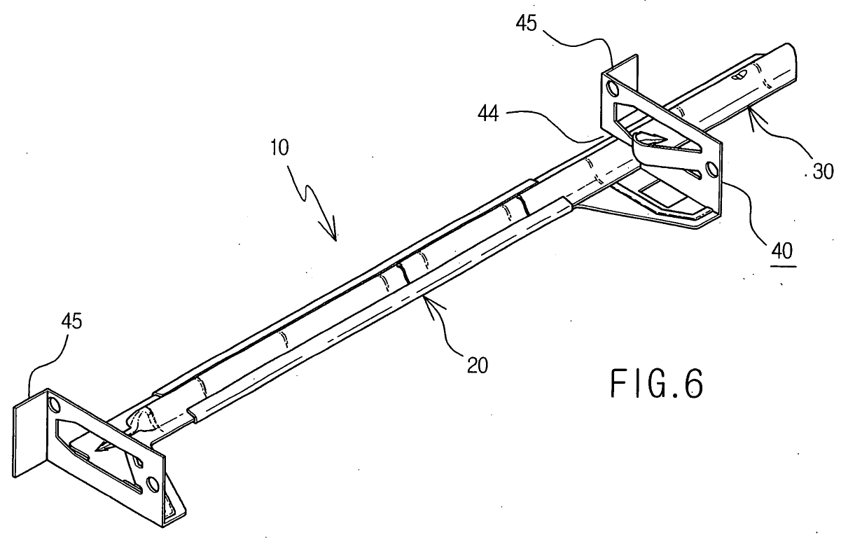

FIG. 6 shows a hanger bar for a ceiling light fixture according to another embodiment of the present invention.

In FIG. 6, an opening part 44 is formed on a side of the coupling part 40 of the first bar 20. When the second bar 30 is mounted to slide in the first bar 20, the second bar 30 passes through the opening part 44 without lodging in the coupling part 40. Therefore, it is possible to shorten the width between coupling parts 40 formed on the first and second bar 20, 30 without cutting the second bar 30. Thus, it is possible to reuse the hanger bar 10 because the length of hanger bar 10 is varied without cutting.

As shown in FIG. 6, as the second bar 30 is slidingly inserted through the opening part 44 formed on the coupling parts 40 for the first bar 20 to fix, a the hanger bar can be installed in narrow width without cutting the second bar. Thus, the hanger bar has flexibility for a width.

Further, as the hanger bar is firstly fixed on a side of the ceiling frame by using the chock 42 formed on the coupling parts 40 and secondly fixed by a screw, a subsidiary 45 can be formed on a side of the coupling parts 40 to protrude in order to maintain the first fixing position constantly.

That is to say, when the subsidiary 45 is positioned on an upper side of the ceiling frame, the chock 42 frame is fixed on the ceiling frame with a regular distance from the upper side. Therefore, the light fixture fixed on the hanger bar is maintained at a level with the ceiling as the ceiling frame is maintained at a level with the hanger bar. Thus, the exterior of the light fixture can be graceful.

As above described, since the hanger bar according to the present invention is formed to be capable of shortening the length thereof, it is possible to mount regardless of the width of the ceiling frame. Further, because of having the chock formed on the coupling part for contacting with the ceiling frame, the hanger bar can be coupled with the ceiling frame by using a simple stroke.

Further, since the hanger bar according to the present invention has two protrusions corresponding to two bars, it is possible to prevent the two bars from separating. Thus, the hanger bar is easily mounted with the ceiling frame.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A hanger bar for mounting a ceiling light fixture, which comprises:
a first bar having a plurality of cutting lines formed at regular intervals and folding hooks formed along the longitudinal direction on both sides of the crosswise direction thereof;
a second bar having a plurality of cutting lines formed at regular intervals and a convex part protruded on one side thereof along the longitudinal direction, wherein the second bar is mounted to slide in the folding hook of the first bar; and
coupling parts for attaching the first and second bars which are formed in each end of the first and second bars as one body and folded perpendicular to the surface of the first and second bars and in which coupling members are formed by punching.

2. A hanger bar for mounting a ceiling light fixture according to claim 1, wherein each coupling member is extended from the corresponding coupling part in a bar-shape, bent in a hook-shape, and has a sharp chock formed in the end thereof toward the direction opposite to the corresponding bar.

3. A hanger bar for mounting a ceiling light fixture according to claim 2, wherein each coupling part further comprises coupling holes for nailing or screwing, which is formed on the upper and lower sides of the corresponding coupling member.

4. A hanger bar for mounting a ceiling light fixture according to claim 3, wherein the first and second bars have first and second protrusions which are formed in the ends of the first and second bars opposite to the coupling parts respectively; and wherein first protrusion is protruded toward the opened direction of the folding hook, the second protrusion is protruded toward the inside of the convex part and the first and second protrusions are hooked each other to prevent the first bar from taking away from the second bar.

5. A hanger bar for mounting a ceiling light fixture according to claim 2, wherein the first and second bars have first and second protrusions which are formed in the ends of the first and second bars opposite to the coupling parts respectively; and wherein first protrusion is protruded toward the opened direction of the folding hook, the second protrusion is protruded toward the inside of the convex part and the first and second protrusions are hooked each other to prevent the first bar from taking away from the second bar.

6. A hanger bar for mounting a ceiling light fixture according to claim 3, wherein the first and second bars have first and second protrusions which are formed in the ends of the first and second bars opposite to the coupling parts respectively; and wherein first protrusion is protruded toward the opened direction of the folding hook, the second protrusion is protruded toward the inside of the convex part and the first and second protrusions are hooked each other to prevent the first bar from taking away from the second bar.

7. A hanger bar for mounting a ceiling light fixture according to claim 4, wherein the coupling part of the first bar has an opening part on a side thereof, and the second bar mounted to slide in the first bar passes through the opening part without lodging in the coupling part.

8. A hanger bar for mounting a ceiling light fixture according to claim 5, wherein the coupling part of the first bar has an opening part on a side thereof, and the second bar mounted to slide in the first bar passes through the opening part without lodging in the coupling part.

9. A hanger bar for mounting a ceiling light fixture according to claim 6, wherein the coupling part of the first bar has an opening part on a side thereof, and the second bar mounted to slide in the first bar passes through the opening part without lodging in the coupling part.

10. A hanger bar for mounting a ceiling light fixture according to claim 7, wherein a subsidiary is formed on the coupling parts for the first and second bars to be protruded in order to maintain a coupling position for the sharp chock and the ceiling frame in constant, the subsidiary being positioned on an upper part of the ceiling frame.

11. A hanger bar for mounting a ceiling light fixture according to claim 8, wherein a subsidiary is formed on the coupling parts for the first and second bars to be protruded in order to maintain a coupling position for the sharp chock and the ceiling frame in constant, the subsidiary being positioned on an upper part of the ceiling frame.

12. A hanger bar for mounting a ceiling light fixture according to claim 9, wherein a subsidiary is formed on the coupling parts for the first and second bars to be protruded in order to maintain a coupling position for the sharp chock and the ceiling frame in constant, the subsidiary being positioned on an upper part of the ceiling frame.
